(19) United States
(12) Patent Application Publication
(10) Pub. No.: US 2026/0076511 A1
(43) Pub. Date: Mar. 19, 2026

(54) AN INSERT AND SIEVE FOR USE WITH A FOOD PROCESSOR

(71) Applicant: DE'LONGHI BRAUN HOUSEHOLD GMBH, Neu-Isenburg (DE)

(72) Inventors: Pascal WOHLFAHRT, Neu-Isenburg (DE); Darja RACHOR, Neu-Isenburg (DE); Antje BORCHMANN, Neu-Isenburg (DE)

(21) Appl. No.: 19/109,164

(22) PCT Filed: Aug. 30, 2023
(86) PCT No.: PCT/EP2023/073848

§ 371 Date: Mar. 6, 2025

(30) Foreign Application Priority Data
Nov. 1, 2022 (GB) 2216229.1
Nov. 3, 2022 (LU) LU103031

(51) Int. Cl. A47J 43/07; A47J 43/044; B01F 33/80; B01F 35/00; B01F 101/00

(52) U.S. Cl. CPC A47J 43/0705; A47J 43/044; B01F 33/83611; B01F 35/188; A47J 2043/04427; A47J 2043/04436; B01F 2101/1805

(57) ABSTRACT

There is disclosed an insert and sieve for use with a food processor having a processing tool, the insert comprising a disc having at least one aperture for the passage of food previously processed by the processing tool and, wherein in the disc is configured to be locatable in a sieve and be removable therefrom. Other aspects are included herein.

### FIELD

The present invention relates to an insert, a sieve, a combination comprising the sieve and insert, and a kit of parts for use with a food processor.

### BACKGROUND

Food processing devices are versatile kitchen appliances, which can be used for multiple processing applications, such as chopping foods into fine pieces or crushing ice cubes into smaller crushed ice.

One way of chopping and ice crushing with a food processing device is to arrange a rotating knife directly in a bowl of the device, for example an ice crusher knife. The food or ice to be processed is placed in the bowl with the rotating knife contacting the material to be processed. The knife is forced to rotate for example by use of an electric motor, and as the knife rotates the blades cut the material into smaller pieces. As the material remains in the volume surrounding the knife, the material is continually contacted by the knife, reducing its size. Whilst effective at reducing the size of the material, this method produces non-uniformly sized product as the knife will contact some pieces of material more than others. It also makes achieving a desired size extremely difficult, as softer material is processed more quickly, making it difficult for a user to gauge how long to process the material.

The present invention aims to remedy these and other problems.

### SUMMARY OF THE INVENTION

As used herein, the term “tool” preferably connotes a shaft for receiving drive, the shaft preferably being provided with one or more food processing tools (e.g., blades or paddles) for processing food.

As used herein, the term ‘disc’ preferably connotes an item that has one, some or all of the following properties: it has a circular cross-section, it is a prism, the thickness of the prism is less than the diameter of the cross-section, the thickness is or is not constant along the radius, it is or is not symmetrical, it features protrusions from any surface, it features indentions in any surface and it features apertures in any surface.

According to the present invention, there is provided an insert for use with a food processor having a processing tool, the insert comprising a disc having at least one aperture for the passage of food previously processed by the processing tool and wherein the disc is configured to be locatable in a sieve and be removable therefrom. The at least one aperture may allow passage of food from a processing volume in which the processing tool is locatable to a container volume to prevent over-processing. The at least one aperture may be of any shape, size, orientation, location, area. Being a disc, the insert may be removed from the sieve in part to make cleaning easier.

The insert preferably includes at least one formation, for enabling location of the insert in the sieve. Preferably the at least one formation is an indentation on the outer circumference of the disc. Preferably the indentation is bevelled on the upper and lower edge, to guide the insert into the correct location. Preferably the indentation has no sharp edges, to reduce risk of injury to the user and/or cracking of the insert from prolonged use. Preferably there is a plurality of apertures on the insert, to increase the area that processed food may pass through, thereby increasing the speed of food processing. The plurality of apertures may be all the same size and shape. Preferably at least one aperture is different to the at least one other apertures in terms of but not limited to shape, size, location, appearance, and orientation. The plurality of apertures may provide a greater total area of passage for the food from the processing to the container volume to reduce the processing time by allowing for increased food processing rate.

The insert preferably has an aperture for a food processing tool. Preferably the aperture extends throughout the thickness of the insert. Preferably the aperture is circular in cross-section. Preferably the aperture is located at the centre of the disc. Preferably the aperture is slightly larger than the mount for the processing tool, to allow easy insertion and removal of the insert without allowing for incorrect assembly of the insert with respect to the processing tool.

Preferably at least one surface of the insert has at least one formation. Preferably the at least one formation is a protrusion. Preferably the insert features a plurality of protrusions on at least one surface of the insert. Preferably the plurality of protrusions is symmetrically spaced on the surface of the insert.

As used herein, ‘upper surface’ preferably connotes the flat surface of the insert from which food processed by the processing tool travels towards and may enter the at least one aperture on the surface of the insert. Likewise, as used herein, ‘lower surface’ preferably connotes the flat surface of the insert from which processed food travels away from having maybe passed through the at least one aperture on the surface of the insert.

The protrusions may be located on the upper surface of the insert, for improving the quality of processed food or reducing the time required to process the food. Preferably the protrusions do not overlap the openings of the at least one aperture. Preferably the protrusions extend radially outwards from the centre of the insert. Preferably the protrusions are solid.

Alternatively, or additionally, the protrusions may be located on the lower surface of the insert, to assist locating the insert in the sieve. Preferably the protrusions have an aperture and are aligned with at least one of the apertures in the sieve. Preferably the protrusions completely encircle at least one aperture. The protrusions may also assist with removing the insert from the sieve.

The insert preferably includes at least one formation located near the centre of the insert. Preferably there is a plurality of formations and preferably these formations take the form of protrusions. Preferably the protrusions are solid and preferably the protrusions are curved. Preferably the protrusions are symmetrical about the centre of the insert. The protrusions can assist with assembly of the insert in the sieve to reduce the risk of assembling the device incorrectly. Preferably the protrusions interfere with the shaft of the processing tool if assembled incorrectly preferably interfering with the processing tool by making it sit too high in the food processor if assembled incorrectly. Preferably the protrusions prevent assembly of the lid onto the device if the insert is assembled incorrectly. The protrusions may be of any shape, size, number and/or orientation.

As used herein, the term ‘bowl’ preferably connotes an item that has one, some or all of the following properties: it has a cylindrical section, one end of the cylindrical section is closed by a surface, the other end is unbounded, it has apertures through a surface and it has formations on a surface.

According to another aspect of the present invention, there is provided a sieve for use with a food processor having a processing tool, the sieve comprising a bowl having at least one aperture for the passage of food previously processed by the processing tool and wherein an insert is locatable and be removable therefrom.

Preferably a plurality of apertures is provided on the sieve, to increase the area that processed food may pass through, thereby increasing the speed of food processing. The plurality of apertures may be all the same size and shape. Preferably at least one aperture is different to the at least one other apertures in terms of but not limited to shape, size and orientation.

Preferably the sieve includes at least one formation for enabling location of the insert in the sieve. Preferably the at least one formation is a protrusion on the inner circumference of the cylindrical surface of the sieve. Preferably the at least one protrusion is bevelled to guide the insert into the correct location. Preferably the at least one protrusion has no sharp edges to reduce risk of injury to the user and/or cracking of the insert from prolonged use.

The sieve preferably includes a mount for locating the processing tool. Preferably the mount is located on the surface bounding the cylindrical section of the sieve. The mount may include but is not limited to all, some of or none of the following features: detachable sections, bearings, seals, braking mechanisms and shafts, and attachment points.

Preferably the sieve includes a formation on the unbounded end of the cylindrical section for engagement with the lid of a food processing device. Preferably the formation is an indentation configured to receive the lid. The sieve may feature a seal for engagement with the lid when assembled.

Preferably the sieve features at least one formation on the outer surface of the sieve at least partially aligned with the at least one aperture on the sieve. Preferably the or each formation features an aperture allowing the passage of food from the sieve apertures. Preferably the formations are protrusions and curve around the exposed apertures of the sieve, to reduce the risk of injury from contact with the processing tool.

Preferably the sieve features at least one, preferably small, formation near the centre of the sieve base. Preferably the formation is an aperture and preferably there is a plurality of apertures. Preferably these apertures are curved and preferably the apertures are symmetrical about the centre of the insert. Preferably the apertures correspond to formations on the insert. Preferably the protrusions on the insert pass through the small apertures on the sieve base if (but only if) the insert is assembled correctly in the sieve. The apertures may be of any shape, size, number and/or orientation.

According to a further aspect of the present invention, there is provided a combination comprising an insert and a sieve, preferably one or both as aforesaid. Preferably at least one insert is locatable in the sieve and removable therefrom. Preferably the formations on the sieve correspond to the formations on the insert thereby allowing for engagement between the two aspects of the invention. Preferably a small tolerance is provided between the formations on the sieve and the insert to reduce the risk of interference during assembly or use.

Preferably, when the insert is located in the sieve, at least one aperture on the insert is aligned with at least part of at least one aperture on the sieve. Preferably all the apertures on the insert are aligned with the at least one of the apertures on the sieve. Preferably the resulting aperture size of the combination of the insert and sieve is smaller than the aperture size of the sieve alone.

The invention also extends to a kit of parts comprising a plurality of inserts preferably as aforesaid, and preferably a sieve. Preferably at least one insert is different to another such insert in terms of but not limited to shape of insert, size of insert, thickness of the insert, number of apertures, size of apertures, orientation of apertures, location of apertures, appearance of apertures, shape of apertures, total area of apertures, individual area of each aperture, number of formations, size of formations, orientation of formations, location of formations and appearance of formations. Hence, in other words a plurality of inserts may be provided, which are interchangeable in the sieve to achieve different resulting apertures sizes or shapes. This allows the user to adjust the results to different finenesses. The invention extends to a food processor incorporating an insert, a sieve and a combination, one, some or all preferably as aforesaid.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

The invention extends to methods, system and apparatus substantially as herein described and/or as illustrated with reference to the accompanying figures.

The invention extends to any novel aspects or features described and/or illustrated herein. In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

Whilst the invention has been described in the field of domestic food processing and preparation appliances, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances. Any reference to “food”, “beverage” (or similar language) herein may be replaced by such working mediums.

The invention described here may be used in any appliance, such as a kitchen appliance, and/or as a stand-alone device. This includes any domestic food-processing and/or preparation appliance, including both top-driven appliances (e.g., stand-mixers) and bottom-driven appliances (e.g., food processors). It may be implemented in heated and/or cooled appliances. The invention may also be implemented in both hand-held (e.g., hand blenders) and table-top (e.g., blenders) appliances. It may be used in an appliance that is built-in to a work-top or work surface, or in a stand-alone device. The invention can also be provided as a stand-alone device, whether motor-driven or manually powered. “Food processing” as described herein should be taken to encompass chopping, whisking, stirring, kneading, mincing, grinding, shaping, shredding, grating, cooking, freezing, making ice-cream, juicing (centrifugally or with a scroll), or other food-processing activities involving the physical and/or chemical transformation of food and/or beverage material by mechanical, chemical, and/or thermal means. “Food processing attachment” encompasses any attachable component configured, for example on rotation and/or energising, to carry out any of the previously described food processing tasks.

### DESCRIPTION OF THE DRAWINGS

The invention will now be described by way of example with reference to the accompanying drawings in which:

FIG. 1 is a view of one embodiment of an assembled food processing device;

FIG. 2 is a view of a different embodiment of an assembled food processing device;

FIG. 3 is a sectional view of a sieve and container with a tool mounted;

FIG. 4 is a view of a sieve with tool inserted;

FIG. 5 is a view of one embodiment of a sieve with protrusions;

FIG. 6 is a view of one embodiment of an insert;

FIG. 7 is a view of a different embodiment of an insert;

FIG. 8 is a view of a further different embodiment of an insert;

FIG. 9 is a view of a yet further different embodiment of an insert;

FIG. 10 is a view of one embodiment of a sieve and insert assembly;

FIG. 11 is a view of a different embodiment of a sieve and insert assembly;

FIG. 12 is a view of a further embodiment of a sieve;

FIG. 13 is a sectional view of one embodiment of a sieve and insert assembly;

FIG. 14 is a sectional view of one embodiment of a sieve with protrusions;

FIG. 15 is a view of one embodiment of the insert with protrusions extending through the sieve.

### SPECIFIC DESCRIPTION

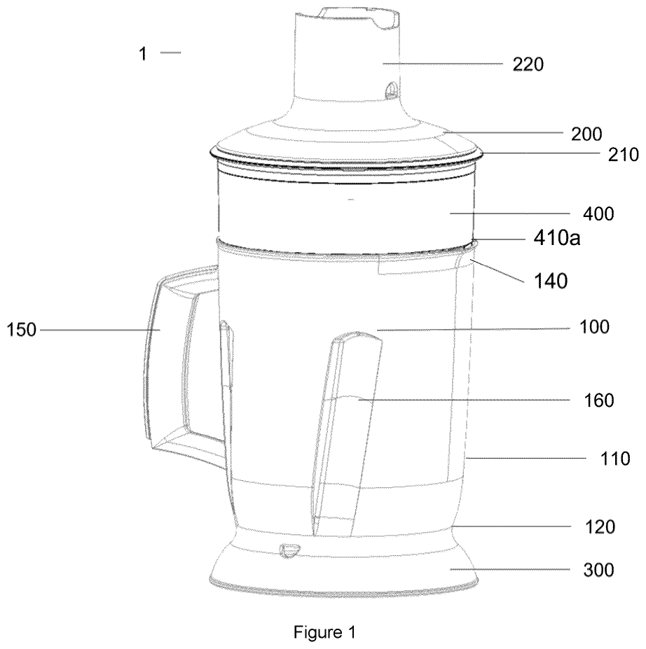

FIG. 1 shows an embodiment of a motor-driven, electrically powered food processor 1 comprising a processor volume 100, a handle 150, a lid 200, a base 300, a sieve 400.

The processor volume 100 is formed by container side walls 110 extending from a base 120. The base 120 is circular in cross-section with the container side walls 110 extending to form a hollow cylindrical space defining the processor volume 100. The processor volume 100 is split into a food processing volume 130 and a container volume 140 by the sieve 400. The container side walls 110 feature at least one indentation 160 to improve handling of the food processor 1; such indentation 160 forms a rib on the inside surface of the container side walls 110 to improve food processing performance especially where the container is used without a sieve or other insert. A handle 150 is provided to aid carrying the food processor 1.

A lid 200 is provided to seal the processor volume 100; the lid 200 may be reversibly attached to the sieve 400. The lid 200 features a shoulder 210 configured to abut the unbounded end of the sieve 400, thereby facilitating location for the user and preventing over-insertion of the lid 200 onto the sieve 400.

One end of the processing volume is bounded by the base 300. The base 300 may be removably attached to or integrally formed with the container side walls 110. The flat under surface of the base 300 provides a stable plane for the food processor to rest on during use or storage.

The container volume 140 and the lid 200 are separated by the sieve 400. The side walls 110 of the processor volume 100 extend to meet a shoulder 410a on the sieve 400. The shoulder 410a is configured to abut the side walls 110, thereby facilitating location for the user and preventing over-insertion of the sieve 400 onto the processor volume 100.

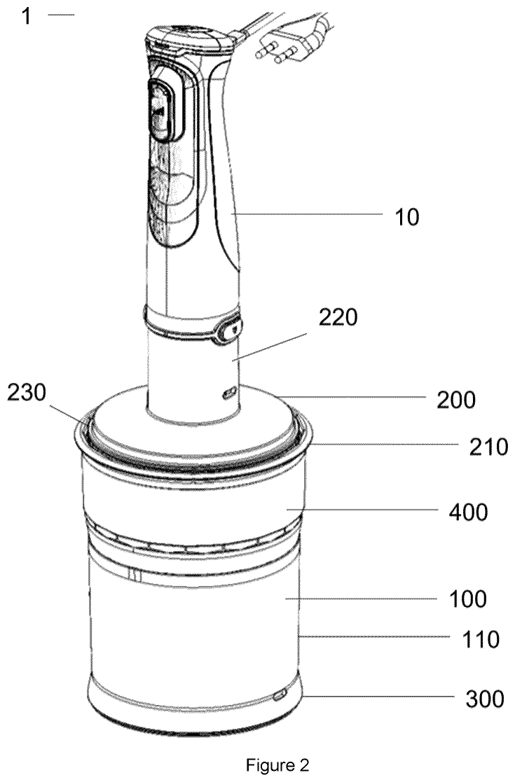

FIG. 2 shows the food processor 1 with a different embodiment of the container volume 140. The lid 200 features a tool mount 220 on a predominately flat external surface. The outer surface of the lid features a flange 230 around its circumference, which abuts an larger flange 210 on an upper part of the sieve 400. The flange 230 is provided to support the force and torque from motor 10 and user during use. A gearbox may be integrated with the lid to change the speed of the processing tool 50.

In one variant, the container side walls 110 of the processor volume 100 are devoid of indentations 160 and a handle 150, thereby making the overall food processing device 1 more compact. This provides advantages to the user in terms of storage and transport. Ribs 112 on the inside surface of the container walls 110 improve the flow of material inside the container when the container is used without the sieve; these ribs 112 are smaller than the ribs formed by the indentations 160 (it is therefore not necessary to have the indentations 160 on the outside). In this variant, a second shoulder 410b is used to locate the sieve 400 on the container side walls 110 allowing for the same sieve 400 to be used with different types of container having different container side walls, or different types of sieve to be used with the same container.

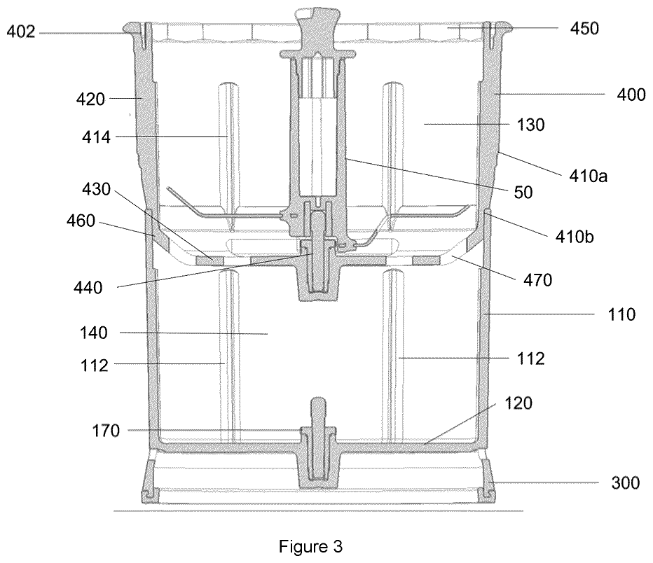

FIG. 3 shows a cross section of the first embodiment of the processor volume 100, the base 300 and the sieve 400. The processor volume 100 is portioned into a processing volume 130 and a container volume 140 by the sieve 400. The processor volume 100 is bounded by the food processor base 120, the side walls 110 and the lid 200. A substantially cylindrical side wall 110 extends upwardly from the base 120 to partially enclose a substantially cylindrical space defining the container volume 140.

A plurality of protrusions 112 extend axially along the cylindrical major axis of the container volume 140 along an inner surface of the side wall 110. The protrusions extend towards the centre of the container volume 140 and taper from the container side walls 110 towards the centre of the container volume 140. The protrusions 112 may be bevelled along any edge to facilitate easier cleaning of the container volume 140. The protrusions 112 interact with the food and improve the processing performance when the processing tool 50 is used directly in the container volume 140, without using the sieve 400 and insert 500, and in some embodiments provide structural rigidity to the side walls 110 The protrusions 112 may be integrally formed with the side walls 110 or may be a separate element attached by gluing or clipping. In a variant the plurality of protrusions 112 are symmetrically spaced around the circumference of the container volume 140.

The sieve 400 is mounted on the unbounded end of the container volume 140. The sieve 400 is predominantly bowl-shaped with cylindrical side walls 420, a base 430 and an unbounded end opposite the base 430.

A plurality of protrusions 414 extends axially along the cylindrical major axis of the sieve along an inner surface of the sieve side walls 420. The plurality of protrusions 414 extend towards the centre of the sieve 400 and taper from the sieve side walls 420 towards the centre of the sieve 400. The protrusions 414 may be bevelled along any edge to facilitate easier cleaning of the sieve 400. The protrusions 414 blend into the base 430 of the sieve 400 to facilitate easier cleaning. The protrusions 414 may be integrally formed with the sieve side walls 420 or may be a separate element attached by gluing or clipping. In a variant the plurality of protrusions 414 are symmetrically spaced around the circumference of the sieve side walls 420. The protrusions 414 provide rigidity to the sieve side walls 420 and improve food processing time and/or quality by interacting with the material being processed. The protrusions 414 also facilitate location for the insert 500.

A tool mount 440 is provided for engagement with a food processing tool 50. The food processing tool 50 comprises two knife elements and a shaft. The shaft is rotated by the motor 10 and as it does so the knife elements contact the material to be processed, reducing the material's size. The knife elements may be of any shape, size, orientation and/or number and may be sharpened, blunt or serrated. The mount is configured to support the food processing tool 50 at one end and may provide axial and lateral resistance. The mount 440 is located in the centre of the base 430. Another tool mount 17 is provided in the container volume 140 located in the centre of the base 120.

The sieve 400 features a groove 402 for engagement with an embodiment of the lid 200 with a larger diameter than shown in FIG. 1 to facilitate location of that lid 200 on the sieve 400. The groove 402 extends circumferentially around the unbounded surface of the sieve 400 and is tapered from the unbounded surface and finishes blind in the sieve side walls 420. The taper allows for easy insertion of the lid 200 onto the sieve 400 then secures the lid 200 as pressure is applied by the user on the lid 200 along the major cylindrical axis of the sieve 400. This groove 402 therefore allows the same sieve to be used with different embodiments of the container and lid.

The region of the inner circumference of the sieve side walls 420 closest to the unbounded end of the sieve 400 features a plurality of formations 450. The formations 450 are a plurality of straight edges around the inner circumference of the sieve side walls 420 joined seamlessly to form an enclosed surface and are configured to restrict relative rotation of the lid 200 and the sieve 400. The formations 450 are bevelled on the edge abutting the unbounded edge of the sieve 400 to allow for easier insertion of the lid 200 onto the sieve 400. The formations 450 are joined seamlessly to the sieve side walls 420 to remove the risk of food, ice or other debris from becoming trapped and so facilitates easier cleaning.

The sieve 400 features a flat base 430 with an angled outer circumference 460 joining the flat base 430 to the sieve side walls 420. There are no seams between the flat base 430, angled outer circumference 460 and sieve side walls 420 to remove the risk of food, ice or other debris from becoming trapped and so facilitates easier cleaning.

The sieve 400 comprises a plurality of apertures 470 through the thickness of the base 430 for the passage of processed food from the processing volume 130 to the container volume 140. The plurality of apertures 470 also extend through the thickness of the angled outer circumference 460 of the sieve 400. The plurality of apertures 470 may either extend perpendicularly to the angled outer circumference 460 or perpendicularly to the sieve base 430. In one variant the edges of the apertures 470 are bevelled to reduce risk of injury from sharp edges and to facilitate easier cleaning.

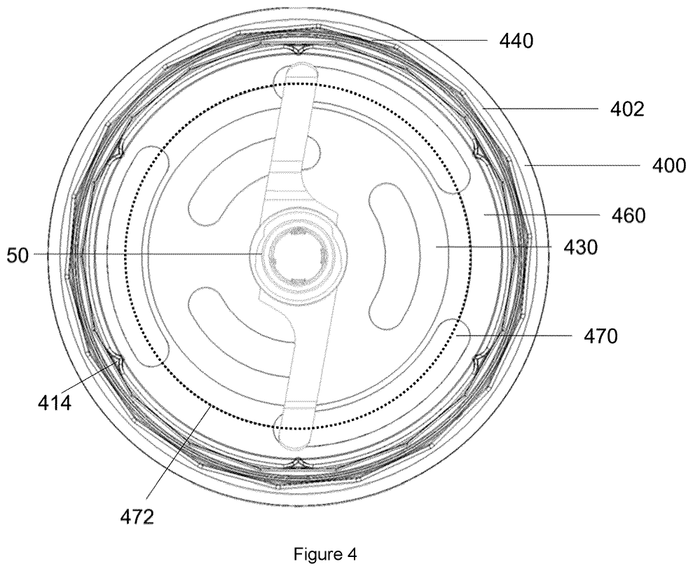

FIG. 4 shows a view of the sieve 400 with the processing tool 50 inserted. The sieve 400 features six apertures 470 having an elongated, curved shape with rounded ends. In a variant there are a plurality of apertures 470 to increase the area that processed food may pass through, reducing processing time and/or changing the fineness of the processed food. To avoid reducing the structural integrity of the sieve base 430, the apertures 470 are narrow and do not extend into each other.

The apertures 470 form part of the circumference of a circle. The distance from the centre of the sieve 400 to the centre of the aperture is defined as the circle radius 472, the circle radius 472 being smaller than the outside of the sieve 400 but larger than the radius of the tool mount 440. The six apertures 470 are located at two different circle diameters 472 with three apertures 470 located on each circle diameter 472. The apertures 470 are oriented out-of-phase so the centres of the inner apertures 470 are halfway between the centres of the outer apertures 470. In a variant the apertures 470 are located on more than two circle radii and/or have different numbers of apertures 470 on each circle radius. The width of the apertures 470 is smaller than the distance between the two circle diameters 472 so that apertures 470 on different circle diameters 472 do not touch or merge. This maintains structural integrity of the sieve base 430. It will be appreciated that different numbers of apertures (for example from 3 or 4 or 5 or 10, to 10, or 20 or 30 or 40) and different numbers of circle diameters (say 3 or 4) may be provided.

The apertures 470 are spaced evenly around the circle diameter, that is to say the distance from the centre of any one aperture 470 clockwise to the centre of the next aperture 470 is equal to the same measurement anti-clockwise. This produces rotational symmetry of the apertures 470 on any one circle diameter 472. The apertures occupy greater than half the circle diameter 472 of the sieve base 430. In a variant the apertures 470 are not evenly spaced around the circle circumference, occupy less than half the circle circumference and/or overlap with the angled outer circumference 460 of the sieve 400.

In a further variant the apertures 470 are spaced in varying distances from the centre of the sieve 500 (and typically not located on a circle circumference). The apertures 470 themselves may comprise any shape (for example elongated) or may be oriented such that the longest extension of the aperture 470 does not extend in circumferential direction, but may be oriented at an angle to it, forming for example a radial or spiral pattern.

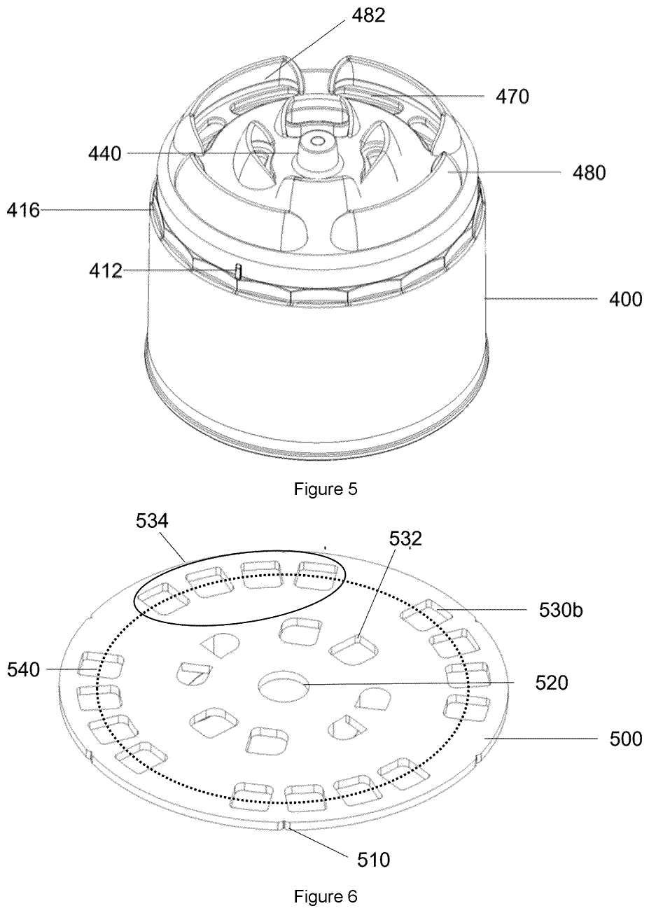

FIG. 5 shows a variant of the sieve 400. The underside of the sieve base 430 features eight protrusions 480 that lie on part of the circumference of a circle, the centre of the protrusions 480 sharing a common circle radius. The protrusions 480 are located on two circle radii, with four protrusions 480 on each circle radius. The circle radii can be any radius between the outer radius of the sieve 400 and the radius of the tool mount 440. The protrusions 480 take the form of a wall offset from and curved around the circle circumference and also curved away from the underside of the sieve base 430. The wall of each protrusion 480 defines an aperture 482 which is located at least partly adjacent to a sieve aperture 470. This forms a pathway for processed food to move from the processing volume 130 through the sieve apertures 470 and protrusion apertures 482 into the container volume 140. The protrusions 480 also offer protection for the user by reducing the risk of accidently touching the processing tool 50 if the food processing tool 50 is used in the sieve 400 without the container 100 in place.

The protrusions 480 on each circle radius are spaced evenly around a circle circumference on the sieve base 430; that is to say the distance from the centre of any one protrusion 480 clockwise to the centre of the next protrusion 480 is equal to the same measurement anti-clockwise. There are protrusions 480 on two different circle radii; the protrusions 480 on a smaller circle radius are smaller in size than the protrusions 480 on a larger circle radius. The protrusions 480 seamlessly meet the underside of the sieve base 430 and the edges of the protrusions 480 are bevelled to reduce risk of injury and facilitate easier cleaning. In a variant, there are a plurality of apertures 470 lying on more than one circle radius; they are not evenly spaced around a circle circumference and/or the size of the protrusions is not linked to their position on the sieve base 430.

The shoulder 410b of the sieve features at least one locating dowel 412 for engagement with the container side walls 110. The at least one locating dowl 412 facilitates easier assembly of the sieve 400 onto the container side walls 110 by providing a pre-alignment between the sieve protrusions 416 and container 100. In one variant there is a single locating dowl 412 that is configured to allow assembly of the sieve 400 onto the container side walls 110 in one orientation only. In another variant there are a plurality of locating dowels 412 spaced evenly around the circumference of the sieve shoulder 410b allowing the sieve 400 to be assembled onto the container side walls 110 in a plurality of orientations. In a different variant the plurality of dowls 412 is configured to only allow the sieve 400 to be assembled onto the container side walls 110 in one orientation.

The sieve shoulder 410b features a plurality of protrusions 416. The protrusions 416 are a plurality of straight edges around the outer circumference of the sieve shoulder 410b joined seamlessly to form an engaging surface. The protrusions 416 may be configured to restrict relative rotation of the sieve 400 and the container side walls 110. The protrusions 416 are bevelled on the outer edge to reduce risk of injury and facilitate easier cleaning.

FIG. 6 shows an insert 500. The insert 500 is disc-like, being flat and circular in cross-section with a thickness smaller than the diameter of the cross-section and a constant thickness through the cross-section. This can permit the compact storage of multiple such inserts and facilitate easier cleaning of each such insert.

There are six formations 510 on the outer circumference of the insert 500. The formations 510 take the form of an indentation with a V-shaped cross-section and extend though the thickness of the insert 500. The formations 510 facilitate location of the insert 500 in the sieve 400. The plurality of indentations 510 are spaced evenly around the circumference of the insert 500; that is to say the distance from the centre of any one indentation 510 clockwise to the centre of the next indentation 510 is equal to the same measurement anti-clockwise. This produces rotational symmetry of the indentations 510 on the insert 500. The edges of the indentations 510 are bevelled to reduce risk of injury from sharp edges and to facilitate easier cleaning. In a variant, there are a plurality of indentations and/or they are not spaced evenly around the outer circumference of the insert 500.

An aperture 520 is provided through the insert 500 for the food processing tool 50. The aperture 520 extends through the thickness of the insert 500 and is configured to allow the insert 500 to be inserted over the mount 440 on the sieve 400. The aperture 520 is circular in cross-section and located in the centre of the insert 500.

The insert 500 features apertures 530 for the passage of processed food from the processing volume 130 to the container volume 140 that extend through the thickness of the insert 500. The apertures 530 are located on part of the circumference of a circle 540. The distance from the centre of the insert 500 to the centre of the circle 540 is defined as the circle radius 540, the circle diameter 540 having a radius smaller than the outer radius of the insert 500 but larger than the radius of the aperture 520. The apertures 530 are located at two different circle diameters 540 with sixteen apertures 530 located on the outer circle diameter 540 and eight on the inner. The width of the apertures 530 is smaller than the distance between the two circle diameters 540 so that apertures 530 on different circle diameters 540 do not touch or merge. This maintains structural integrity of the insert 500. It will be appreciated that different numbers of apertures, clusters and/or circle diameters may be provided.

The apertures 530 and 532 may be of any size, number, orientation, angle relative to the insert 500 surface and shape. A plurality of examples is described herein for example but should not be considered limiting with respect to the apertures 530 and 532. For instance, in a variant the apertures 530b have a rectangular cross section with rounded corners. The radius of the corners may be constant across all corners or may differ between at least one corner and at least one other corner. The apertures 530b are orientated so the centre point of one straight edge extended parallel to the edge is tangential to a circle diameter 540 on the insert 500. Four outer apertures 530b are grouped together to form a cluster 534 with this variant having four outer clusters 534 spaced evenly around a single circle diameter 540; that is to say the distance from the centre of any one cluster 534 clockwise to the centre of the next cluster 534 is equal to the same measurement anti-clockwise. In one variant the edges of the apertures 530b are bevelled to reduce risk of injury from sharp edges and to facilitate easier cleaning.

This variant of the insert 500 features eight apertures 532 that extend through the thickness of the insert 500 and are located on a smaller circle diameter 540 than the 16 outer apertures 530b. The apertures 532 have a rectangular cross-section with rounded corners. The radius of the corners may be constant across all corners or may differ between at least one corner and at least one other corner. In this variant some of the apertures 532 have a D-shaped cross-section comprising a flat edge, two predominantly flat edges and a curved edge joined to the two predominantly flat edges, thereby defining the perimeter of the cross-section. The cross-section of the at least one aperture 532 is constant through the thickness of the insert 500. The corners of this variant of aperture 532 may be sharp or have a small radius to improve food processing quality, reduce time or facilitate easier cleaning.

The insert apertures 530 can be of any number or shape. They are located so that they overlap or at least partially overlap the apertures 470 in the sieve 400. The size, number and location of the apertures 530 has the effect that the combined apertures formed by sieve 500 and insert 400 are smaller in size and/or number than the sieve apertures 470 alone. This has the effect that the food needs to be processed into finer pieces before it can pass through the apertures. A number of different execution examples are given in the next paragraphs.

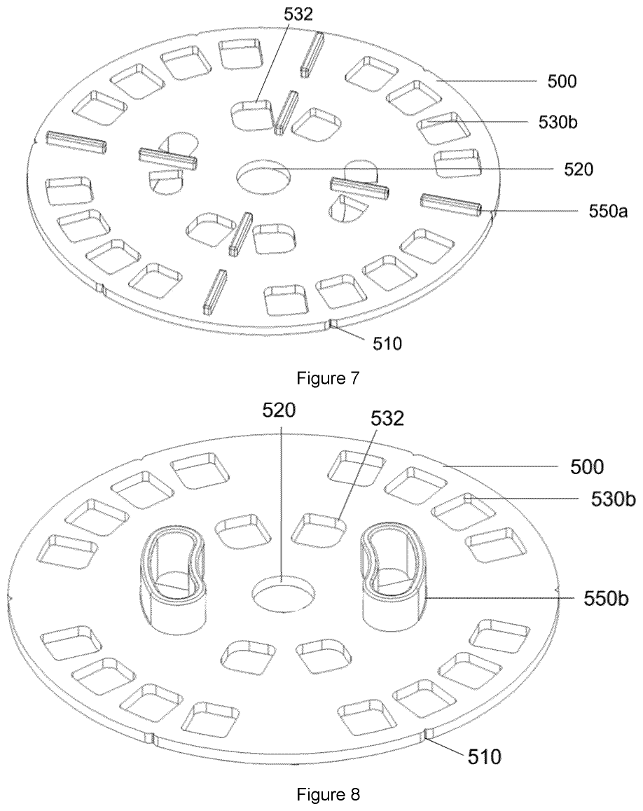

FIG. 7 shows a different embodiment of the insert 500 with symmetrical protrusions 550. FIG. 7 shows the top side of a variant of the insert 500 with eight protrusions 550a on a surface of the insert 500 to improve food processing quality and/or time. The eight protrusions 550a take the form of a cuboid with bevelled edges and corners and are extruded above the insert 500 a similar distance to the thickness of the insert 500. The protrusions 550a are arranged with the major axes of the cuboids aligned parallel to the radius of the insert 500. The centres of the protrusions 550a lie on a circle radius 540 of the inserts 500. The protrusions 550a are arranged on two circle radii 540 with at four protrusions 550a located on each circle radius 540. The protrusions 550a have rotational symmetry due to their spacing and orientation. In another variant there are a plurality of protrusions 550a of any shape, size, number, location and/or orientation that lie on a surface of the insert 500. The protrusions may be integrally formed with the inert 500 or may be a separate element attached by gluing or clipping.

FIG. 8 shows the bottom side of the variants shown in FIG. 6 or 7 (or also any other variant) of the insert 500 with two protrusions 550b on a surface of the insert to facilitate removal of the insert 500 from the sieve 400. The protrusions 550b also prevent incorrect assembly of the insert 500 and the sieve 400 as the processing tool 50 cannot be assembled onto the tool mount 440 unless the insert 500 is in the correct position with the protrusions 550b being inserted into the matching apertures 470 of the sieve. If the protrusions 550b are not inserted into the sieve apertures 470, the insert 500 is offset from the bottom of the sieve 400, making it impossible to attach the processing tool 50 correctly and to close the lid 200. The protrusions 550b take the form of extrusions enclosing at least part of an aperture 532. The protrusions 550b are a curved shape with a wall enclosing a central aperture located adjacent to at least part of one aperture 532. The centres of the protrusions 550b lie on the same circle radius 540 and this may correspond to the circle radius 540 of the apertures 532 or 510. The protrusions 550b are equally spaced around the circle diameter 540; that is to say the distance from the centre of any one protrusion 550b clockwise to the centre of the next protrusion 550b is equal to the same measurement anti-clockwise and this produces rotational symmetry of the protrusions 550b on the insert 500. In a variant there is a plurality of protrusions 550b, and the centres of the plurality of protrusions 550b lie on at least one circle radius 540 and/or are not spaced equally. The at least one protrusion 550b has a bevelled outer edge to reduce risk of injury and facilitate easier cleaning. The insert 500 may feature either or both protrusions 550a and 550b. The protrusions 550b are shaped in a way as to match the sieve apertures 470 thereby allowing the protrusions 550b to be inserted into said apertures 470 when assembled correctly.

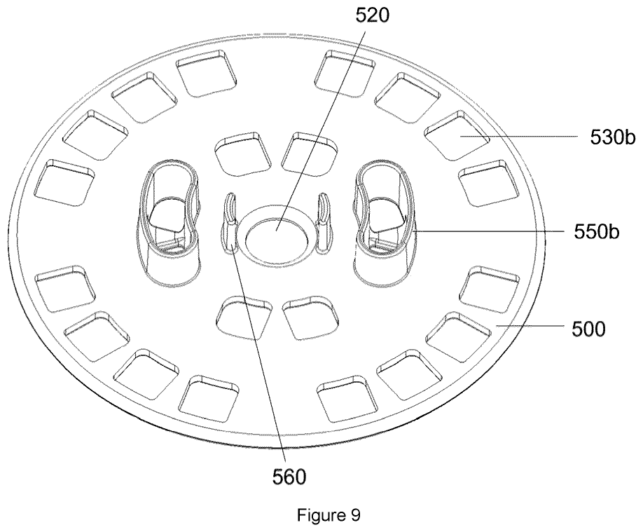

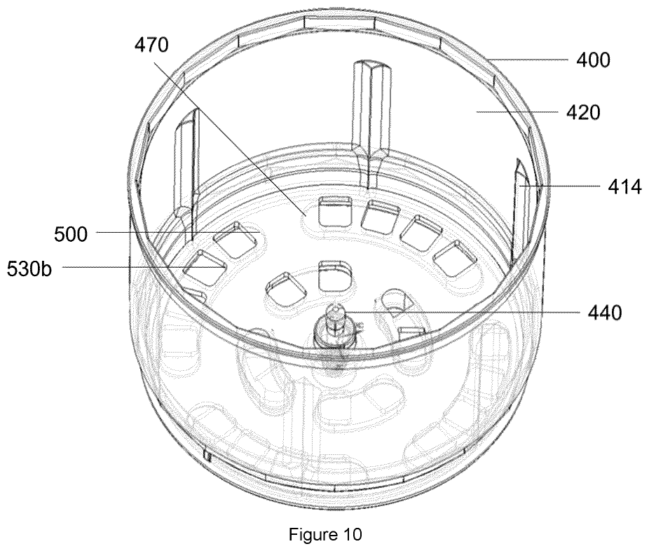

FIG. 9 shows a variant of the insert 500 with the features shown in FIG. 8 and additional protrusions 560 located near the central aperture 520 which in this embodiment features a chamfer on one surface. The two protrusions 560 are curved around and offset from the central aperture 520. The purpose of the additional protrusions 560 is to prevent incorrect assembly of the sieve 400 and insert 500 by interfering with the processing tool 50. If the user places the insert 500 in the sieve 400 the wrong way round, the additional protrusions 560 will prevent the blades of the processing tool 50 cutting into the larger protrusions 550b. The additional protrusions 560 will interfere with the shaft of the processing tool 50 and prevent assembly of the tool 50 in the processor assembly 1. If the user still tries to close the lid 200 with the incorrectly assembled processing tool 50, the lid 200 will not close as the processing tool 50 will be sitting too high within the sieve 400. It is to be understood that in preventing incorrect assembly of the sieve 400 and insert 500, the protrusions 560 may be any number, size, shape or orientation.

FIG. 10 shows an embodiment of a combination of the sieve 400 and the insert 500, as shown in FIG. 6. In FIG. 10 the insert 500 is assembled into the sieve 400 correctly, with the protrusions 550b inserted into the matching sieve apertures 470.

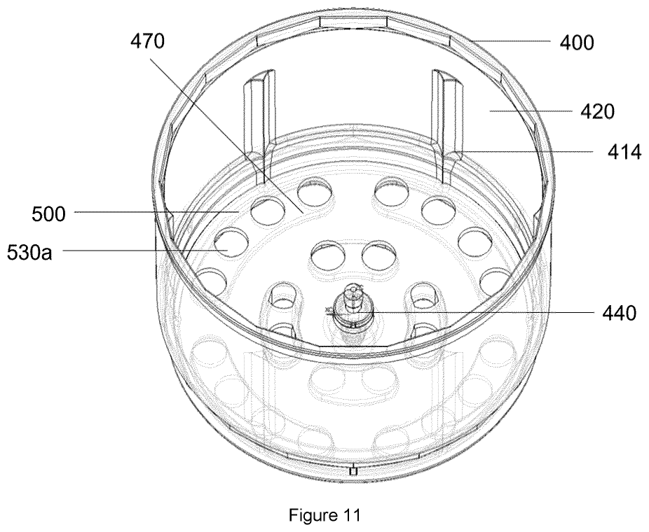

FIG. 11 shows a different embodiment of a combination of the sieve 400 and the insert 500 with different insert apertures 530a. In both of the FIGS. 10 and 11, the insert 500 rests on the sieve base 430 with the insert indentations 510 aligned with the sieve protrusions 414. A small clearance is provided between the insert 500 and the sieve 400 resulting in a loose fit, allowing for easy assembly or disassembly of the combination of the sieve 400 and the insert 500.

The insert apertures 530 are aligned with the sieve apertures 470 so that at least part of at least one of the insert apertures 530 is adjacent to at least part of at least one sieve aperture 470. This forms a passage from the food processing volume 130 to the container volume 140.

As used herein, ‘apparent aperture area’ is defined preferably as the area of through which food can move from the food processing volume 130 to the container volume 140.

In the variant shown in FIGS. 10 and 11 all the insert apertures 530 are located adjacent to the sieve apertures 470 so the resulting apparent aperture area is equal to the area of the insert apertures 530. In the variants shown in FIGS. 10 and 11, the area of the insert apertures 530 is less than the area of the sieve apertures 470. In a different variant the sieve base 430 at least partly reduces the apparent aperture area by overlapping at least partly with at least one aperture 530 and/or at least one insert aperture 530 is not aligned with a sieve aperture 470 when the combination of sieve and insert is assembled. This may be used to improve food processing quality and/or reduce food processing time.

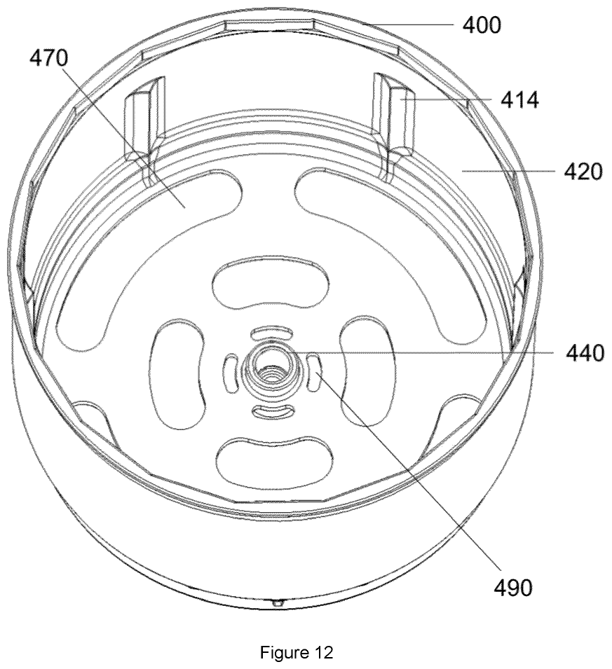

FIG. 12 shows an embodiment of the sieve 400 for use with the insert 500 embodiment shown in FIG. 9. In addition to the features discussed previously, there are small apertures 490 for engagement with the additional protrusions 560 on the insert 500. If the insert 500 is inserted into the sieve 400 correctly (with the additional protrusions 560 facing towards the sieve base 430), then the additional protrusions 560 will extend through the small apertures 490 in the sieve 400 and allow normal assembly of the insert 500 in the sieve 400. The apertures 490 correspond with the additional protrusions 560 and may be of any number, size, shape or orientation.

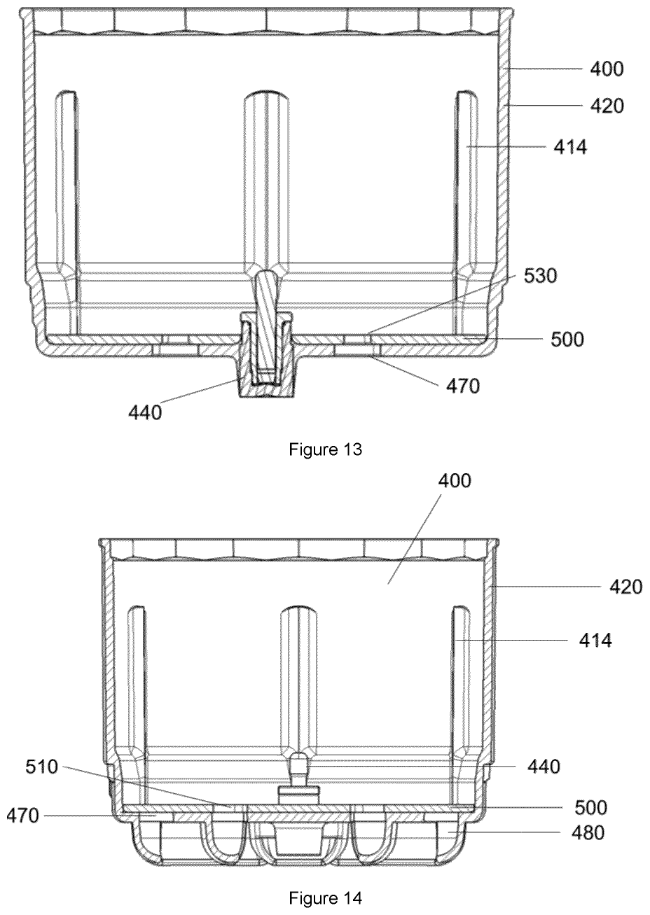

FIG. 13 shows a cross section of the assembled sieve 400 and the insert 500 combination. The sieve 400 has a flat base 430 extending to meet the sieve side walls 420 with no intermediate section. The insert 500 rests on the sieve base 430 with the tool mount 440 protruding through the aperture 520 of the insert. At least part of at least one insert aperture 530 is shown aligned with at least part of at least one sieve aperture 470.

FIG. 14 shows a cross-section of a different embodiment of the sieve 400 and the insert 500 combination. The sieve 400 features protrusions 480 with the insert aperture 530, sieve aperture 470 and protrusion aperture 482 forming a passage from the food processing volume 130 to the container volume.

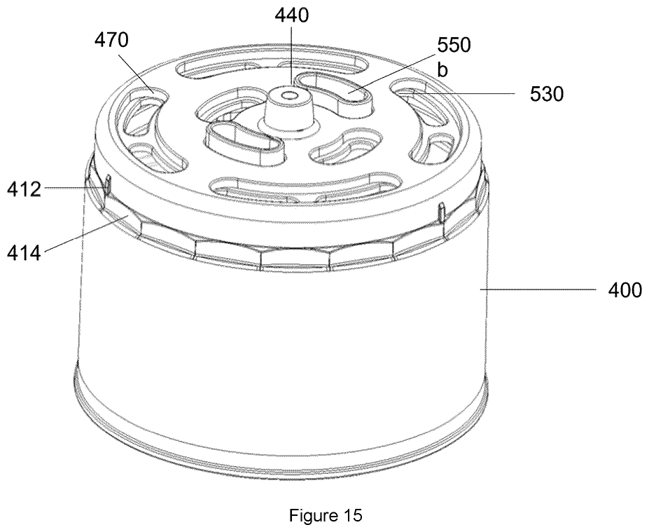

FIG. 15 shows a bottom view of an embodiment of the sieve 400 and the insert 500 combination assembled. The insert 500 features protrusions as shown in FIG. 8 extending through the sieve base 430. In the variant shown the insert 500 features elongate apertures 530, thus forming two through apertures for each aperture 470 in the sieve 400.

In an embodiment, there is provided a container volume 140, a sieve 400 and a lid 200 which closes the sieve 400 towards the top and to which a motor unit 10 can be attached to drive a food processing tool 50 inside. A food processing tool 50 rotates in the sieve 400 with apertures 470 on the base 430 to chop the food or ice. When the parts are small enough to enter the apertures 470, the parts will fall into the collection volume 140 and will no longer be chopped, thus achieving a very uniform processing result. For the chopping process also some ribs 414 are needed in the sieve 400 to improve the performance and make the process even faster. The processing tool 50 is driven by a motor unit 10 which is connected to the lid 200 of the attachment and rotates on a mounted shaft in the lower area of the sieve 400, there is also the possibility to have a gear box inside the lid 200 for reducing the speed of the blade rotation.

An insert 500 may be inserted into the bottom of the sieve 400. The insert 500 has a different aperture 530 pattern to the sieve 400, which overlaps with the apertures 470 in the sieve 400 and generates a new resulting hole pattern. This resulting hole pattern has a smaller overall hole surface area, thus making the end result finer. Theoretically an infinite number of inserts 500 can be provided, allowing to ideally adjust the device 1 to every possible food, application or market. This allows to better adapt the device 1 to the food that is to be processed.

In addition to varying the apertures, also the top surface of the insert 500 can be varied. For example; inserts 500 can be fitted with different ribs, different surface structures, patterns or can be made from different materials, to further adapt to a certain application.

The ribs or structures 550 can for example have the effect of slowing down the motion of the food particles or to propel them upwards towards the processing tool 50, resulting in finer, faster or more even results, depending on the food, for which this insert 500 is intended.

The size of the apertures 530 has the biggest effect on the size and evenness of the food and crushed ice pieces. More apertures 530 with a certain width will bring a more even result than apertures 530 which are longer but have the same width. The insert 500 may overlap the apertures 470 of the sieve 400 so that the sieve apertures 470 are no longer in effect.

To assemble the insert 500 into the sieve 400, the insert 500 is placed on the sieve base 430, before the processing tool 50 is installed. The protrusions 550b on insert 500 enter two of the apertures 470 in the sieve and rotationally lock the insert 500 in place.

The protrusions 550b protrude out of the sieve base 430 and also serve as a disassembly aid for the user. To disassemble the user can push the insert 500 upwards by pushing the protrusions 550b, making it easy to remove the insert 500 from the insert 400.

If the insert 500 is not pushed down far enough (or if the protrusions 500b are not lined up with the apertures 470 in the sieve 400 correctly), the processing tool 50 cannot be installed, because the insert 500 will sit too high inside the sieve 400, blocking the correct assembly of the processing tool 50. This will be clearly noticeable to the user, because in this condition it is not possible to close the lid 200, and therefore preventing use of the processor 1 in incorrectly assembled conditions.

It is theoretically possible to operate the sieve 400 (including processing tool 50, lid 200 & motor unit 10), without a collection container 140 in place. In this condition, users with small fingers could theoretically reach through the apertures 470 on the underside of the sieve 400 and touch the rotating processing tool 50. To minimise this risk, a number of protector ribs 480 may be located around the apertures 470. The ribs 480 partially obstruct the apertures 470, making it more unlikely to reach through them with a finger, while at the same time they maintain the same cross section as the apertures 470, so the transition of the food particles is not affected.

Operation of the invention is as follows. The insert 500 is placed into the sieve 400. The formations 510 on the insert 500 engage with the protrusions 414 of the sieve 400 allowing the insert 500 to rest on the base 430 of the sieve 400. The interlocking formations 414 510 prevent relative rotation between the sieve and insert. The sieve 400 and insert 500 assembly can then be placed onto the food processor container side walls 110. A food processing tool 50 may then be engaged with the mount 440 on the sieve 400 and the lid 200 placed onto the sieve 400.

Rotation of the food processing tool 50 by the motor unit 10 causes the food to be reduced in size by contact between the food and the tool 50. Once smaller than the size of the apertures 530 in the insert 500, the food moves through the apertures 530 and 470 and optionally 454 and 482 into the container volume 140, preventing it from being further processed.

The insert 500 is interchangeable with other such inserts that may be different, for example by having varying size, shape, orientation and/or number of apertures 530 to allow the user to alter the properties of the processed food. Removal of the insert 500 is facilitated by the protrusions 550b extending below the sieve base 430 allowing the user to press the insert 500 towards the unbounded end of the sieve 400 once the sieve 400 has been remove from the container volume 140. The formations 550b also assist with location of the insert 500 on the sieve 400.

The formations 550a on the insert 500 are provided to improve food processing quality and/or time by interacting with the material during processing. Protrusions 480 on the sieve 400 prevent injury of the user by contact with the food processing tool 50 during operation and guide the processed food from the apertures 482 into the container volume 140.

As used herein, the term “removable attachment” (and similar terms such as “removably attachable”), as used in relation to an attachment between a first object and a second object, preferably connotes that the first object is attached to the second object and can be detached (and preferably re-attached, detached again, and so on, repetitively), and/or that the first object may be removed from the second object without damaging the first object or the second object; more preferably the term connotes that the first object may be re-attached to the second object without damaging the first object or the second object, and/or that the first object may be removed from (and optionally also re-attached to) the second object by hand and/or without the use of tools (e.g. screwdrivers, spanners, etc.). Mechanisms such as a snap-fit, a bayonet attachment, and a hand-rotatable locking nut may be used in this regard.

As used herein, the term “processing” preferably connotes any action relating to or contributing towards transforming products into foodstuff, or transforming foodstuff into a different form of foodstuff, including-as examples-applying mechanical work (e.g. for cutting, beating, blending, whisking, dicing, spiralising, grinding, extruding, shaping, kneading etc.) and applying heat or cold. “Food” and “foodstuff” as used herein can include beverages and frozen material and material used in creating them (e.g., coffee beans). “Food safe” in this context means any substance that does not shed substances harmful to human health in clinically significant quantities if ingested. For example, it should be BPA-free. “Dishwasher safe” means that it should be physically and chemically stable during prolonged exposure to the conditions prevailing within a dishwasher machine. For example, it should be able to withstand exposure to a mixture of water and a typical dishwasher substance (e.g., washing with Fairy™ or Finish™ dishwasher tablets and water, at temperatures of 82 degrees centigrade for as long as 8 hours without visibly degrading (e.g., cracking)).

It will be understood that the present invention has been described above purely by way of example, and modifications of detail can be made within the scope of the invention. Each feature disclosed in the description, and (where appropriate) the claims and drawings may be provided independently or in any appropriate combination.

Reference numerals appearing in the claims are by way of illustration only and shall have no limiting effect on the scope of the claims.

1-25. (canceled)

26. An insert for use with a food processor having a processing tool, the insert comprising;
a disc having at least one aperture for the passage of food previously processed by the processing tool;
wherein the disc is configured to be locatable in a sieve and be removable therefrom.

27. The insert according to claim 26, wherein the disc includes at least one formation for enabling location of the insert in the sieve.

28. The insert according to claim 27, wherein the at least one formation is located on the outer circumference of the insert.

29. The insert according to claim 26, wherein a plurality of apertures is provided for the passage of food previously processed by the processing tool; and
wherein at least one of the plurality of apertures is different to another aperture.

30. The insert according to claim 26, wherein the insert has an aperture for the processing tool.

31. The insert according to claim 26, wherein the surface of the disc has at least one formation, preferably wherein a plurality of symmetrically spaced such formations is provided, optionally wherein the formations surround at least one aperture, optionally wherein the formations extend in a direction radially from the centre of the disc.

32. The insert according to claim 26, further comprising the sieve for use with a food processor.

33. A sieve for use with a food processor having a processing tool, the sieve comprising;
a bowl having at least one aperture for the passage of food previously processed by the processing tool;
wherein an insert is locatable therein and removable therefrom.

34. The sieve according to claim 33, wherein the sieve includes at least one formation for enabling location of an insert in the sieve.

35. The sieve according to claim 33, wherein the sieve includes a mount for locating the processing tool.

36. The sieve according to claim 33, wherein the sieve includes a formation for engagement with the lid of a food processing device.

37. The sieve according to claim 33, wherein the sieve has at least one formation on its outer surface at least partially adjacent to at least one aperture on the sieve.

38. A combination comprising:
a sieve for use with a food processor having a processing tool, the sieve having a bowl with at least one aperture for the passage of food previously processed by the processing tool; and
an insert comprising a disc having at least one aperture for the passage of food previously processed by the processing tool; and wherein the disc is configured to be locatable in the sieve and be removable therefrom.

39. The combination according to claim 38, wherein the disc and the sieve each include at least one formation for enabling location of the insert in the sieve, and wherein the formations on the insert and sieve are engageable with each other.

40. The combination according to claim 38, wherein when the insert is located in the sieve, at least one aperture on the insert is aligned with at least part of at least one aperture on the sieve.

41. The combination according to claim 38, wherein a plurality of apertures on the insert align with at least one aperture on the sieve.

42. A kit of parts comprising a plurality of inserts according to claim 26, wherein at least one such insert is different to another such insert.

43. The kit of parts according to claim 42 further comprising a sieve comprising;
a bowl having at least one aperture for the passage of food previously processed by the processing tool;
wherein any one of the plurality of inserts is locatable therein and removable therefrom.

44. A food processor comprising a kit of parts according to claim 43

45. A food processor incorporating an insert according to claim 26, and a sieve comprising;
a bowl having at least one aperture for the passage of food previously processed by the processing tool;
wherein the insert is locatable therein and removable therefrom.
